(19) United States
(12) Patent Application Publication
(10) Pub. No.: US 2014/0308069 A1
(43) Pub. Date: Oct. 16, 2014

(54) EXPANDABLE ADHESIVE FOR JOINING VEHICLE COMPONENTS

(71) Applicant: Honda Motor Co., Ltd., Tokyo (JP)

(72) Inventors: Eric J. Boettcher, Columbus, OH (US); Benjamin J. Meaige, Dublin, OH (US); Robb L. Augustine, Dublin, OH (US)

(73) Assignee: Honda Motor Co., Ltd., Tokyo (JP)

(21) Appl. No.: 14/206,323

(22) Filed: Mar. 12, 2014

Related U.S. Application Data
(60) Provisional application No. 61/810,838, filed on Apr. 11, 2013.

(51) Int. Cl. B32B 9/04; B32B 37/12; B32B 37/14; B32B 15/00

(52) U.S. Cl. CPC B32B 9/041; B32B 15/00; B32B 37/1207; B32B 37/144
USPC 403/270; 156/60; 156/330; 156/91

(57) ABSTRACT

A joint includes a first body, a second body, and an adhesive. The first body includes a coated portion and an uncoated portion. The second body includes a coated portion and an uncoated portion. The adhesive is positioned on the uncoated portion of each of the first and second bodies. The adhesive is expandable to cover at least a part of the coated portion of each of the first and second bodies. The first body and the second body can be fabricated for dissimilar materials. The adhesive includes insulating properties that can insulate the first body from the second body to inhibit galvanic corrosion. During a method of forming a joint between a first body and a second body, the adhesive can be at least partially cured so as to hold the first body and second body in the proper relative alignment during the formation process.

### REFERENCE TO RELATED APPLICATION

This application claims priority of U.S. provisional patent application Ser. No. 61/810,838, filed Apr. 11, 2013, and hereby incorporates this provisional patent application by reference herein in its entirety.

### TECHNICAL FIELD

The present application relates generally to an adhesive for joining vehicle components, and more specifically, the present application relates to an expandable adhesive positioned in a joint formed by a pair of joining vehicle components.

### BACKGROUND

Vehicles such as automobiles are assemblies of many structural components such as body panels, frame components, hood panels, and the like. Vehicles can be assembled by joining such components together. One method of joining vehicle components is to create joints between two components and secure such joint using adhesives and/or fasteners.

### SUMMARY

In accordance with one embodiment, a joint includes a first body, a second body, and an adhesive. The first body includes a coated portion and an uncoated portion. The second body includes a coated portion and an uncoated portion. The adhesive is positioned on the uncoated portion of each of the first and second bodies. The adhesive is expandable to cover at least a part of the coated portion of each of the first and second bodies.

In accordance with another embodiment, a method of making a joint includes providing a joint. The joint includes a first body, a second body, and an expandable adhesive therebetween. The method of making a joint includes coating the joint and expanding the adhesive to cover at least a portion of the coating on each of the first and second bodies.

In accordance with another embodiment, a joint includes a first body, a second body, and an adhesive. The first body and the second body are fabricated from dissimilar metals. The adhesive is positioned between the first body and the second body. The adhesive includes insulating properties that insulate the first body from the second body to inhibit galvanic corrosion.

In accordance with yet another embodiment, a method of making a joint includes providing a joint. The joint includes a first body, a second body, and an expandable adhesive therebetween. The first body is steel and the second body is aluminum. The method of making a joint further includes partially curing the adhesive to fix the first body with respect to the second body, coating the joint, and fully curing the adhesive by baking the joint in an oven. The adhesive cooperates with the first and second bodies to maintain an alignment of the joint established during partially curing the adhesive. The oven is at a temperature of 150° C. or greater.

### BRIEF DESCRIPTION OF THE DRAWINGS

It is believed that certain examples will be better understood from the following description taken in conjunction with the accompanying drawings in which:

FIG. 1 is a schematic view of a joint including a first body and a second body in accordance with one embodiment;

FIG. 2 is a schematic view of the joint depicted in FIG. 1 further including an adhesive;

FIG. 3 is a schematic view of the joint depicted in FIG. 2 further including a fastener;

FIG. 4 is a schematic view of the joint depicted in FIG. 3 with a surface conditioner applied to the exposed surfaces of the first body and the second body;

FIG. 5 is schematic view of a prior art joint;

FIG. 5A is a schematic view of the detail 5A of FIG. 5;

FIG. 6 is a schematic view of the joint of FIG. 4 with a protective coating applied and where the adhesive has expanded; and

FIG. 6A is a schematic view of the detail 6A of FIG. 6.

### DETAILED DESCRIPTION

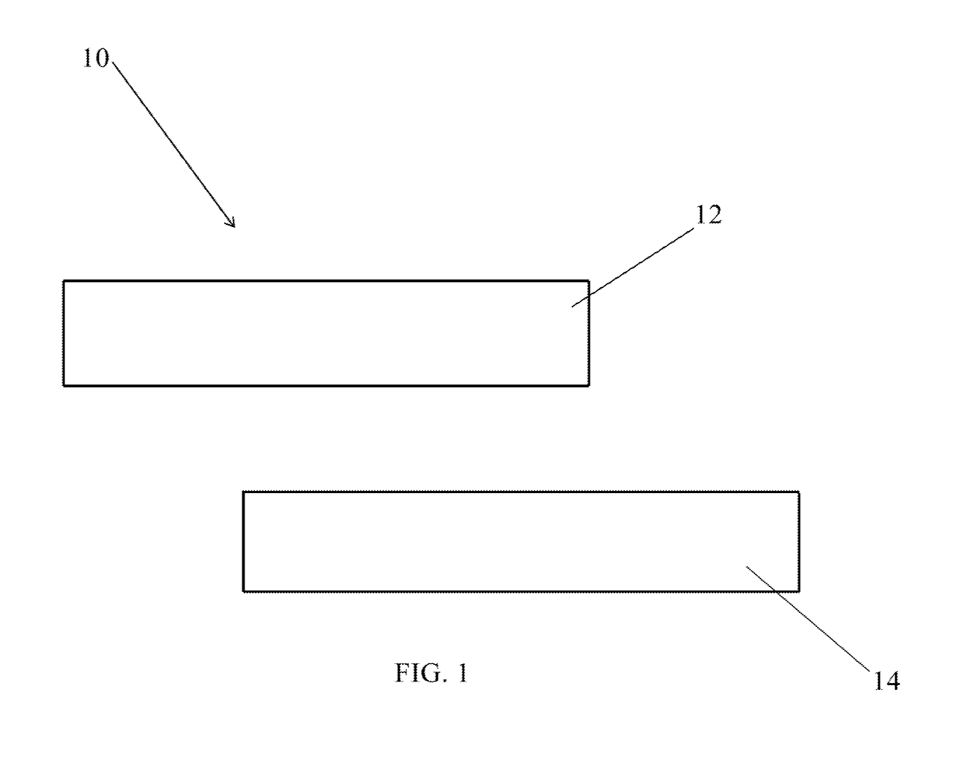

The apparatuses and methods disclosed in this document are described in detail by way of examples and with reference to the figures. It will be appreciated that modifications to disclosed and described examples, arrangements, configurations, components, elements, apparatuses, methods, etc. can be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Selected examples of expandable adhesives for joining two vehicle components are hereinafter disclosed and described in detail with reference made to FIGS. 1-6.

Two structural components of the vehicle can be coupled or jointed together by forming a joint between the two structural components. The structural components can be joined together rigidly or can be joined together so as to permit relative motion between the two structural components. A vehicle, such as an automobile, can include a body that can be substantially supported by a frame, where the body can include a number of panels such as body panels and a hood.

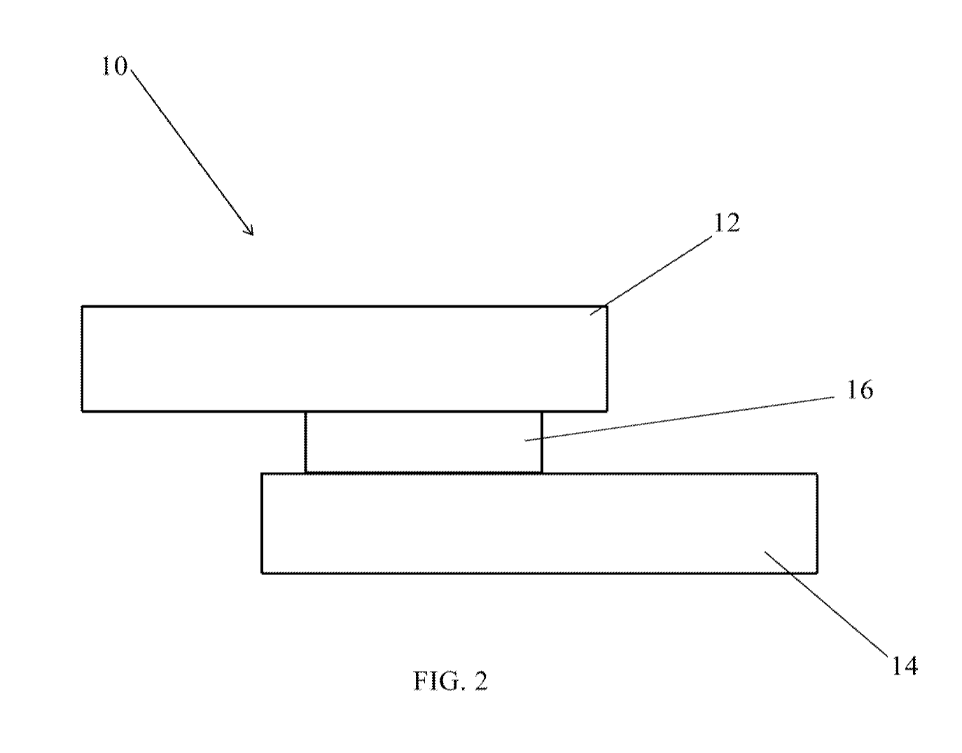

In one example, schematically illustrated in FIGS. 1-3, a joint 10 can be formed between a first body 12 and a second body 14 with an adhesive 16 positioned between the first body 12 and the second body 14. In one example, the first body 12 can be a hood panel and the second body 14 can be a body panel. However, it will be understood that a joint can be formed from any of a variety of other vehicular components or other bodies in any of a variety of suitable configurations. As illustrated in FIG. 1, in preparation for forming the joint 10, the first body 12 and the second body 14 can be placed adjacent to one another. As illustrated in FIG. 2, an adhesive 16 can be placed between the first body 12 and the second body 14, and the first body 12 and the second body 14 can be moved towards one another so that the adhesive 16 comes into contact with both the first body 12 and the second body 14.

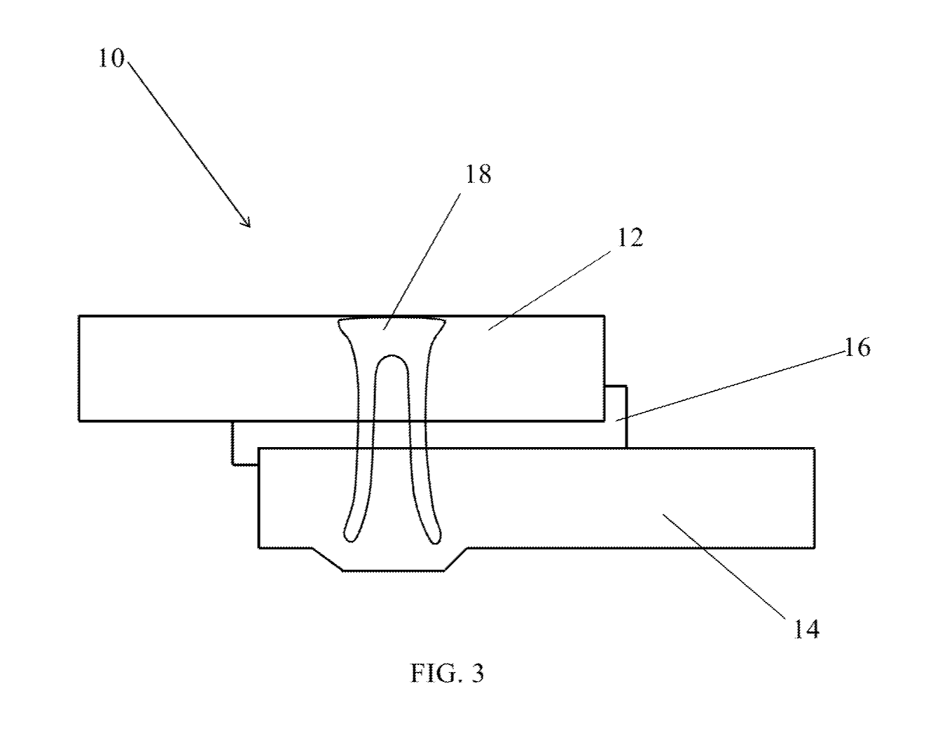

As illustrated in FIG. 3, a fastener 18 can be inserted through the first body 12, second body 14, and adhesive 16 to form the joint 10. The fastener 18 can be inserted in a manner that facilitates a sustained connection between the first body 12 and second body 14. In one example, the fastener 18 can be a rivet, but it will be understood that a fastener can be any of a variety of other types of suitable mechanical fasteners. The process of inserting the fastener 18 can apply a pressure such that the first body 12 and the second body 14 progressively move toward one another. Such movement of the first body 12 and the second body 14 can apply pressure on the adhesive 16 and result in the adhesive 16 flowing so as to move toward and past the edges of the first body 12 and second body 14, as illustrated in FIG. 3.

In another example, a joint can be formed without a fastener 18. A temporary apparatus such as a clamp can be used to secure the first body 12 and second body 14 in relative position until the adhesive 16 is cured. Or the adhesive 16 can be at least partially cured early in the joint formation process so that the fastener 18 is not needed.

As will be described below, the adhesive 16 can be arranged to provide a number of features or functions for the joint 10. For example, the adhesive 16 can be arranged to be expandable when exposed to heat. Such an expandable adhesive 16 can spread along surfaces of the first body 12 and second body 14 so as to cover and protect surfaces that are otherwise uncoated and/or exposed. In another example, the adhesive 16 can include properties that upon partial curing of the adhesive 16 will secure the first body 12 and second body 14 in a proper relative alignment to accommodate additional processing steps of forming the joint 10 such as applying corrosive prevention layers or applying paint layers. In another example, the adhesive 16 can include insulating properties so that the first body 12 is insulated from the second body 14 so as to inhibit galvanic corrosion.

Vehicle components such as body panels, hood panels, and other such components can be formed, for example, from a metal or metal alloy or another material, such as plastic or fiberglass. It will be understood that vehicle components can be formed from any of a variety of suitable materials. Thus, in certain examples, a joint can include a first body and a second body that are formed from similar or dissimilar materials. In one example, dissimilar materials can be used by forming the first body 12 of the joint 10 from steel, and forming the second body 14 of the joint 10 from aluminum. In such an example, the first body 12 and the second body 14 can have different physical and/or mechanical properties. In one example, the first body 12 and the second body 14 can have different coefficients of linear thermal expansion.

When the materials are dissimilar, the joint 10 can be arranged such that the arrangement provides protection to the first body 12 and second body 14 against galvanic corrosion when the first body 12 and second body 14 come into contact with an electrolyte such as dissolved road salt. One arrangement that can offer protection against galvanic corrosion is the positioning of the adhesive 16 between the first body 12 and second body 14. Such positioning of the adhesive 16 can provide physical separation between the first body 12 and the second body 14. As described above, when the joint 10 is formed, the movement of the first body 12 toward the second body 14 can result in the adhesive 16 flowing so as to move toward and past the edges of the joint 10 to form a separation layer between the first body 12 and the second body 14. Furthermore, when the adhesive 16 is formed so that it functions as an insulator, the adhesive 16 can facilitate isolation of the galvanic potential between the first body 12 and the second body 14. Thus, the first body 12 and the second body 14 can be isolated and insulated by the adhesive 16 within a framework of the joint 10.

In addition to protection provided by the adhesive 16, the joint 10 can be coated with a corrosion prevention layer. The corrosion prevention layer can be an epoxy-based coating. In one example, the coating can be applied by an electrodeposition coating process, also known as e-coating. In such example, e-coating can include any of a variety of suitable methods for e-coating, any of which can be used to apply a corrosion preventing layer to a joint 10.

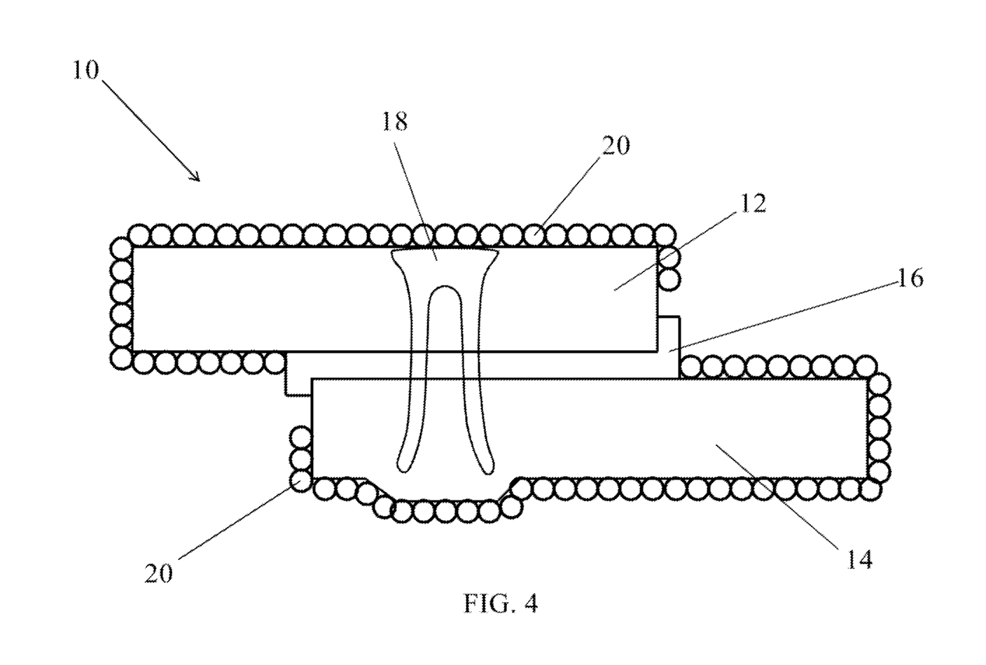

E-coating can be preceded by cleaning and/or treating the exposed surfaces of the first body 12 and the second body 14, which can provide sufficient phosphatability to facilitate proper coating formation. As illustrated in FIG. 4, a surface conditioner 20 can be applied to the exposed surfaces of the first body 12 and the second body 14 to facilitate the coating of the joint 10. Generally, e-coating can include submerging the joint 10 into an electrodeposition bath in an e-coating tank, which can include, a binder resin, a synthetic resin, and optionally, a pigment and other additives dissolved or dispersed in a solvent. In an example, an epoxy resin can be used, along with any of a variety of other suitable resins.

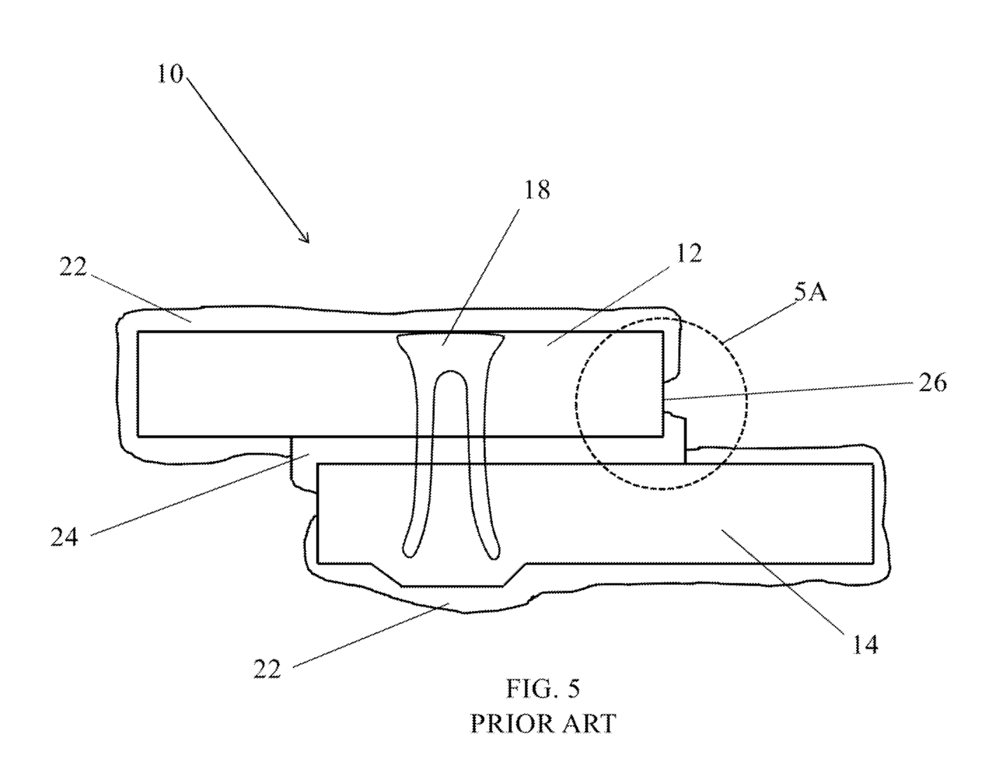

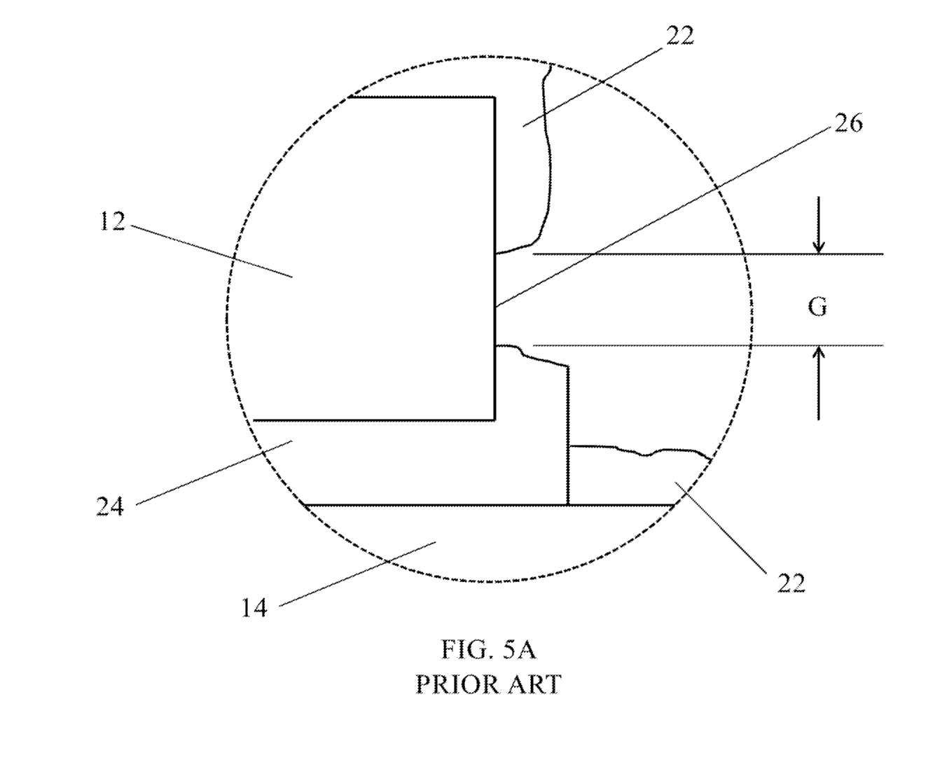

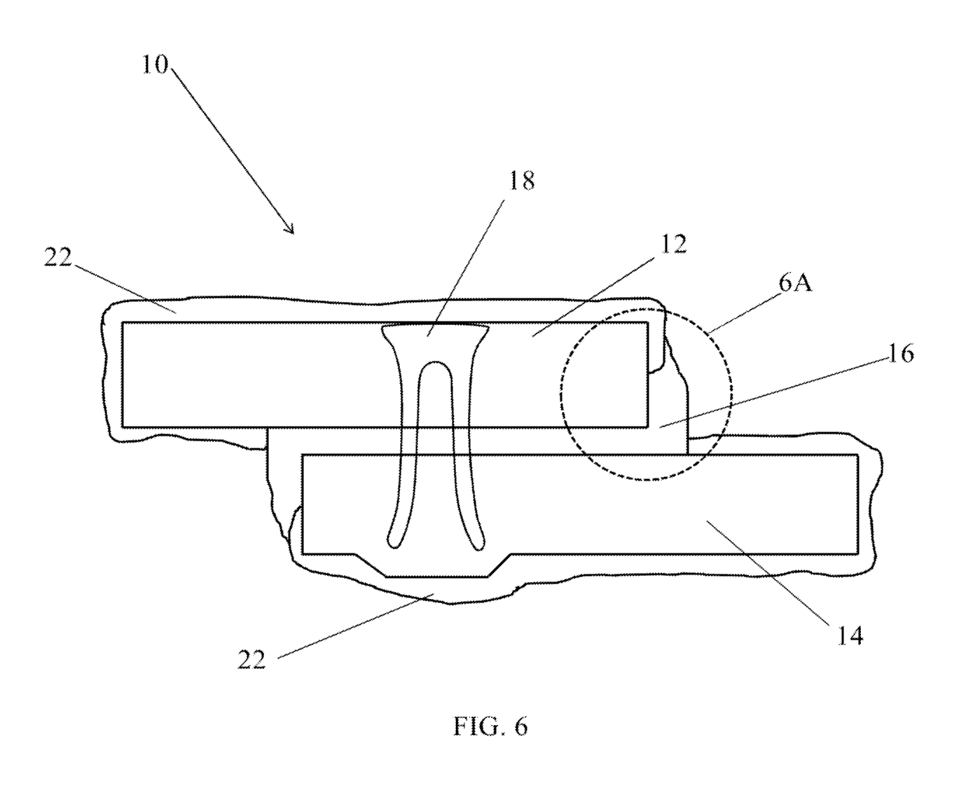

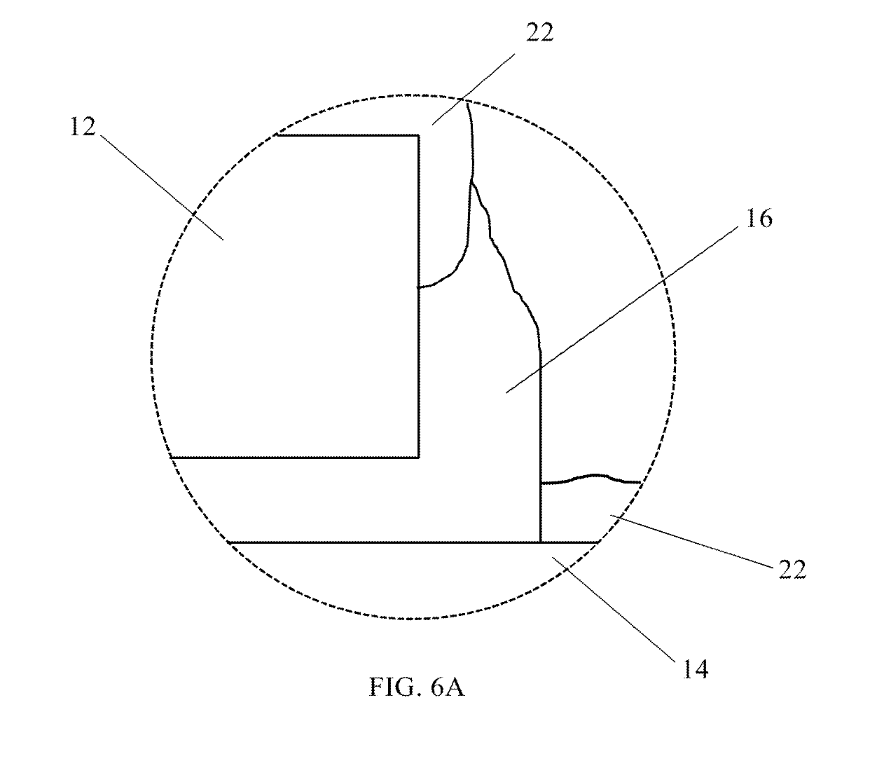

Upon immersion into the e-coating tank, the joint 10 can come into contact with electrodes such that a voltage can be applied between the cathode and an anode to provide current through the electrodeposition bath resulting in the application of a protective coating 22 on the joint 10. Such a protective coating 22 is illustrated in FIGS. 5 and 6. In one example, the joint 10 can undergo electrodeposition one or more times, and in some embodiments, the joint 10 can be washed between coatings, post-coating, or both.

When the process of applying a protective coating 22 as described herein is performed with prior art adhesives 24, portions of the first body 12 and second body 14 can remain unprotected after the protective coating 22 has been applied to the joint 10. As illustrated in FIGS. 5 and 5A, the use of a prior art adhesive can result in the first body 12 including an unprotected section 26. In one example, as will be described below, the joint 10 undergoes one or more heating processes during the application of the protective coating 22 and any subsequent applications of paint. Some prior art adhesives 24 can shrink during heating processes. As illustrated in FIG. 5A, such shrinkage can result in a gap G between the prior art adhesive 24 and the protective coating 22 that exposes a section 26 of the first body 12 to potential corrosion. As is also illustrated in FIGS. 5 and 5A, the second body 14 can include a similar exposed section. The exposed section 26 can result in corrosion of the joint 10. In another example, if the surface conditioner 20 is not effective at the interface of the first body 12 and second body 14, a similar gap G can result and a section 26 of the first body can be exposed.

The adhesive 16 can be an expandable adhesive, and in certain examples, partial curing can cause the adhesive 16 to expand to cover the exposed section 26 of the first body 12 as illustrated in FIGS. 6 and 6A. In other examples, the adhesive 16 can be expandable upon fully curing. The adhesive 16 can also expand to cover the exposed section of the second body 14. In some examples, partial curing can be effected by one or more chemical processes and/or preliminary and localized heating of the adhesive 16 such that any effects of thermal expansion of the first body 12 and/or second body 14 can be minimized. However, it will be appreciated that any of a variety of suitable methods can be employed to effect sufficient partial curing of an adhesive.

In one example, the adhesive can be an adhesive as described and disclosed in WIPO Patent Application WO/2006/128722, entitled Toughened Epoxy Adhesive Composition, and filed on Jun. 2, 2006, which is incorporated herein by reference. In another example, the adhesive can be the adhesive described and disclosed in WIPO Patent Application WO/2006/128722 and further including a foaming agent.

After the protective coating 22 is formed, the protective coating 22 can be cured by baking the joint 10 in an oven. In certain examples, the oven can be heated to about 150° C. or greater; in other examples, the oven can be heated to about 180° C. or greater; and in other embodiments, the oven can be heated to about 195° C. or greater.

The joint 10 can be arranged to rely on the adhesive 16 to facilitate maintaining an alignment of the first body 12 and the second body 14. In such embodiments where the first body 12 and the second body 14 are formed from dissimilar materials, the properties of the materials can be considered. For example, dissimilar materials, such as steel and aluminum, can expand at different rates when heated to temperatures associated with the e-coat bake (i.e., first body 12 and the second body 14 can include different coefficients of linear thermal expansion). Uneven expansion during thermal loading as well as uneven contraction during thermal relaxation can create stress on the joint 10 and particularly on the adhesive 16 when the adhesive 16 is fully cured. To account for this, the adhesive 16 applied to the joint 10 can be partially cured prior to the e-coat bake to fix the first body 12 with respect to the second body 14 before coating the joint 10. Such an arrangement can facilitate maintaining functionality of the adhesive 16 through an e-coat process. The adhesive 16 can be partially cured such that it can facilitate sustaining the connection between the first body 12 and the second body 14 during the e-coat and can retain sufficient flexibility to endure the uneven thermal expansion of the first body 12 and the second body 14 during the subsequent e-coat bake. Thus, the adhesive 16 can cooperate with the first body 12 and second body 14 to maintain alignment through both the coating and subsequent baking of the joint 10 after partially curing the adhesive 16. In certain examples, the adhesive 16 can be fully cured in the oven, along with the coating 20, during the e-coat bake.

Thus, in certain examples, the joint 10 can include an adhesive 16 that can be effective where the first body 12 has a first coefficient of linear thermal expansion and the second body 14 has a second coefficient of linear thermal expansion, such that the first and second coefficients of linear thermal expansion are different. In one example, when partially cured, the adhesive 16 can withstand a pressure of 10 MPa.

The adhesive 16 can undergo the expansion described herein while fully curing in the oven during the e-coat bake. In one example, in arrangements where the adhesive 16 expands during partial curing, the adhesive 16 can undergo additional expansion while fully curing.

In some example, a foaming agent can be combined with a base resin composition to provide an adhesive with a desired expanding effect. It will be appreciated that a joint can include any of a variety of suitable adhesives, foaming agents, and combinations thereof such that sufficient expansion can be affected to provide desired protection.

According to one example, a method of making a joint 10 can include providing the joint 10 including the first body 12, the second body 14, and the expandable adhesive 16 therebetween. The method can further include coating the joint 10 and expanding the adhesive 16 to cover at least a portion of the coating 20 on each of the first and second bodies 12, 14. In some embodiments, the method can further include partially curing the adhesive 16 to fix the first body 12 with respect to the second body 14. And in such embodiments, the method can further include fully curing the adhesive 16 by baking the joint 10 in an oven, wherein the adhesive 16 can expand to cover at least a portion of the coating 22 on each of the first and second bodies 12, 14 and the adhesive 16 can cooperate with the first and second bodies 12, 14 to maintain an alignment of the joint 10 established during partially curing the adhesive 16.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather, it is hereby intended the scope of the invention be defined by the claims appended hereto.

What is claimed is:

1. A joint comprising:
a first body having a coated portion and an uncoated portion;
a second body having a coated portion and an uncoated portion; and
an adhesive positioned on the uncoated portion of each the first and second bodies, the adhesive expandable to cover at least a part of the coated portion of each of the first and second bodies.

2. The joint of claim 1, wherein the first body is a metal or metal alloy and the second body is a dissimilar material.

3. The joint of claim 2, wherein the first body is steel and the second body is aluminum.

4. The joint of claim 2, wherein the first body has a first coefficient of linear thermal expansion and the second body has a second coefficient of linear thermal expansion, such that the first and second coefficients of linear thermal expansion are different.

5. The joint of claim 1, wherein the adhesive cooperates with the first and second bodies to maintain alignment through both a coating and subsequent baking of the joint and after partial curing of the adhesive.

6. The joint of claim 1 further comprising a fastener, the fastener joining the first and second bodies with the adhesive positioned therebetween.

7. A method of making a joint, the method comprising:
providing a joint comprising a first body, a second body, and an expandable adhesive therebetween;
coating the joint; and
expanding the adhesive to cover at least a portion of the coating on each of the first and second bodies.

8. The method of claim 7, wherein the first body is metal or metal alloy and the second body is a dissimilar material.

9. The method of claim 8, wherein the first body is steel and the second body is aluminum.

10. The method of claim 8, wherein the first body has a first coefficient of linear thermal expansion and the second body has a second coefficient of linear thermal expansion, such that the first and second coefficients of linear thermal expansion are different.

11. The method of claim 7, wherein the coating is an epoxy-based coating.

12. The method of claim 7, further comprising partially curing the adhesive to fix the first body with respect to the second body before coating the joint.

13. The method of claim 12, wherein the adhesive expands a first amount during partial curing.

14. The method of claim 13, further comprising fully curing the adhesive by baking the joint in an oven subsequent to coating the joint.

15. The method of claim 14, wherein the adhesive expands a second amount during full curing.

16. The method of claim 12, wherein the adhesive cooperates with the first and second bodies to maintain alignment through both the coating and subsequent baking of the joint and after partially curing the adhesive.

17. The method of claim 7, wherein expanding the adhesive is achieved in an oven at a temperature of greater than 150° C.

18. The method of claim 14, wherein fully curing the adhesive is achieved in an oven at a temperature of greater than 180° C.

19. The method of claim 7, wherein the joint further comprises a fastener, the fastener joining the first and second bodies with the adhesive positioned therebetween.

20. A method of making a joint, the method comprising:
providing a joint comprising a first body, a second body, and an expandable adhesive therebetween, wherein the first body is steel and the second body is aluminum;
partially curing the adhesive to fix the first body with respect to the second body;
coating the joint, wherein the coating is an epoxy-based coating; and
fully curing the adhesive by baking the joint in an oven; wherein:
the adhesive expands to cover at least a portion of the coating on each of the first and second bodies;
the adhesive cooperates with the first and second bodies to maintain an alignment of the joint established during partially curing the adhesive; and
the oven is at a temperature of 150° C. or greater.
